(19) United States
(12) Patent Application Publication
(10) Pub. No.: US 2015/0096258 A1
(43) Pub. Date: Apr. 9, 2015

(54) DOOR ASSEMBLY

(71) Applicant: Foshan Ideal Co., Ltd., Foshan (CN)

(72) Inventor: Wuxiang Wei, Foshan (CN)

(73) Assignee: Foshan Ideal Co., Ltd., Foshan (CN)

(21) Appl. No.: 14/170,141

(22) Filed: Jan. 31, 2014

(30) Foreign Application Priority Data
Oct. 9, 2013 (CN) 201320619322.5

(51) Int. Cl. E06B 3/06; E06B 1/52; E06B 1/18; E06B 3/72

(52) U.S. Cl. CPC E06B 3/06; E06B 3/72; E06B 1/52; E06B 1/18
USPC 52/656.4

(57) ABSTRACT

A door assembly is disclosed which comprises a stationary frame and a movable frame, wherein the door assembly further comprises an adjusting assembly comprising a fixing element detachably connected with the stationary frame and having a cavity, the cavity having oppositely a first inner wall and a second inner wall, the first inner wall being provided with a first engaging element; an adjusting element detachably connected with the movable frame and having a adjusting block, the adjusting block being capable of being received within the cavity and defining a adjusting cavity together with the second inner wall, the adjusting block being provided with a second engaging element; and a locking element capable of extending into the adjusting cavity so as to engage the first engaging element with the second engaging element.

### CROSS-REFERENCE TO RELATED APPLICATIONS

This application claims priority benefit from Chinese utility model application No. 201320619322.5, filed on Oct. 9, 2013, the disclosure of which is incorporated herein by reference in its entirety.

### FIELD OF THE INVENTION

The present invention relates to a door assembly, and in particular, to an adjusting assembly used therein for the adjusting of a stationary frame and a movable frame of the door assembly.

### BACKGROUND OF THE INVENTION

Doors, such as shower doors or balcony doors, are often mounted against wall surfaces and the doors thus mounted are kept as vertical as possible. However, the wall surfaces of buildings are often not exactly vertical, for example, titled toward outside/inside by an angle. Therefore, if the doors are mounted completely along the wall surfaces, the doors may not be smoothly opened or closed. In this regard, it is necessary to adjust the distances between the top/bottom end of a door and a wall surface so as to keep the door in a vertical position.

To achieve this adjustment, a door assembly usually comprises a stationary frame to be attached to a wall surface, and a movable frame connected with a door panel, such as a glass door panel. The stationary frame is firstly attached to the wall surface and then the movable frame is moved toward the stationary frame, during which the distances between the top and bottom ends of the movable frame, and the stationary frame are such adjusted that the movable frame is in a vertical position, and in turn, the door panel is also in a vertical position. The stationary and movable frames are finally connected to each other by drilling thereon and by using fasteners.

However, in one aspect, the drilling operation requires at least two people to cooperate and is very time-consuming. In another aspect, the drilling may inadvertently cause damages to the surfaces of the frames (generally made of aluminum materials), which is undesirable to consumers.

### SUMMARY OF THE INVENTION

An object of the present invention is to provide a door assembly which can be mounted without drilling. Another object of the invention is to provide a door assembly that can be mounted by a single person.

To achieve the objectives, a door assembly is provided which comprises a stationary frame and a movable frame. The door assembly further comprises an adjusting assembly comprising a fixing element, an adjusting element and a locking element. The fixing element is detachably connected with the stationary frame and has a cavity, the cavity having oppositely a first inner wall and a second inner wall, the first inner wall being provided with a first engaging element. The adjusting element is detachably connected with the movable frame and has a adjusting block, the adjusting block being capable of being received within the cavity and defining an adjusting cavity together with the second inner wall, the adjusting block being provided with a second engaging element. The locking element is capable of extending into the adjusting cavity so as to engage the first engaging element with the second engaging element.

The extended or inserted locking element would act on the inner wall of the adjusting cavity, such that the adjusting element would be forced toward the first inner wall and that the second engaging element would act on the first engaging element. In this way, the relative position between the adjusting element and the fixing element can be fixed and therefore the relative position between the stationary frame and the movable frame can be fixed.

Preferably, the second inner wall is provided with a third engaging element for fixing the locking element.

Preferably, the locking element extends into the adjusting cavity through a locking through hole provided in the movable frame.

Preferably, the locking element is a screw, a pin or a wedge block.

Preferably, the first engaging element and the second engaging element are both tooth shaped structures.

Preferably, the fixing element is provided with first slots, and the stationary frame is provided with protuberances received within the first slots. More preferably, the fixing element is further provided with a first through hole, and the fixing element is connected with the stationary frame by a screw matching with the first through hole.

Preferably, the adjusting element is provided with a base, the movable frame is provided with second slots for receiving the base, and the base is provided with a second through hole for passing through of the locking element. More preferably, the base is provided with a bolt and a bolt hole, and engagement of the bolt and the bolt hole keeps the base engaged in the second slots.

The door assembly of the present invention is preferably a shower door assembly, a balcony door assembly or other sliding doors, more preferably a shower door assembly.

The door assembly provided in the present invention can be assembled without drilling operation, minimizing risk of damage to the frames, and can be assembled by a single person.

### BRIEF DESCRIPTION OF THE DRAWINGS

FIG. 1 shows an explosive view of an exemplary door assembly according to one embodiment of the invention.

FIG. 2 shows the detailed structure of the fixing element in FIG. 1.

FIG. 3 shows the detailed structure of the adjusting element in FIG. 1.

FIG. 4 shows the door assembly in FIG. 1 in an exemplary mounting way.

FIG. 5 shows the sectional view of the door assembly in FIG. 1 after mounting.

Elements that are irrelevant to the spirit of the present invention are omitted for clarity.

### DETAILED DESCRIPTION OF THE INVENTION

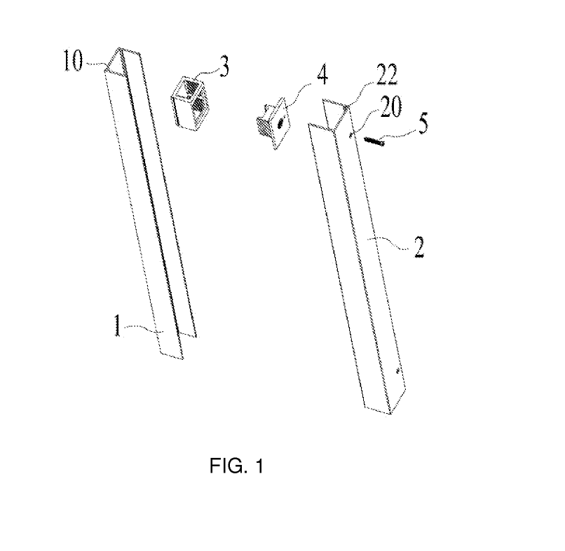

FIG. 1 shows an exemplary door assembly which is a shower door assembly used generally in a bathroom. The shower door assembly comprises a stationary frame 1, a movable frame 2 and an adjusting assembly. The adjusting assembly comprises a fixing element 3, an adjusting element 4 and a locking element 5.

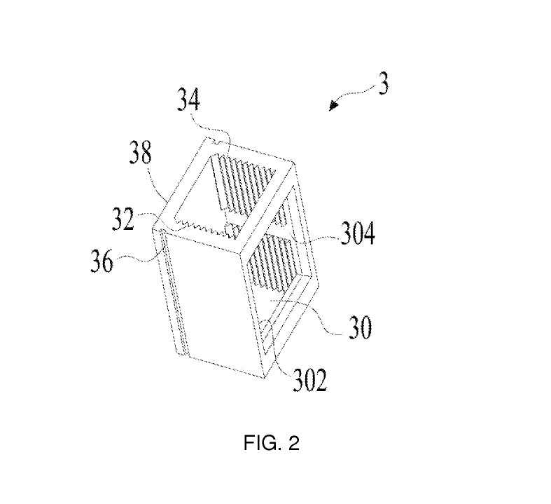

As shown in FIG. 2, the fixing element 3 has a cavity 30. The cavity 30 is provided with a first inner wall 302 (being sheltered) and a second inner wall 304 on opposite sides. The first inner wall 302 is provided with a first engaging element 32.

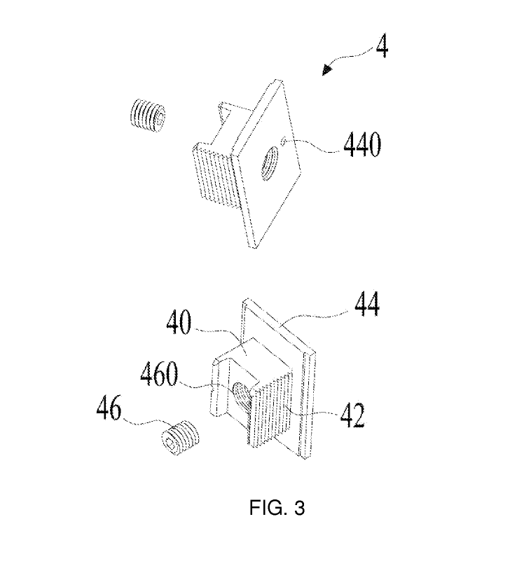

As shown in FIG. 3, the adjusting element 4 has an adjusting block 40 and a second engaging element 42.

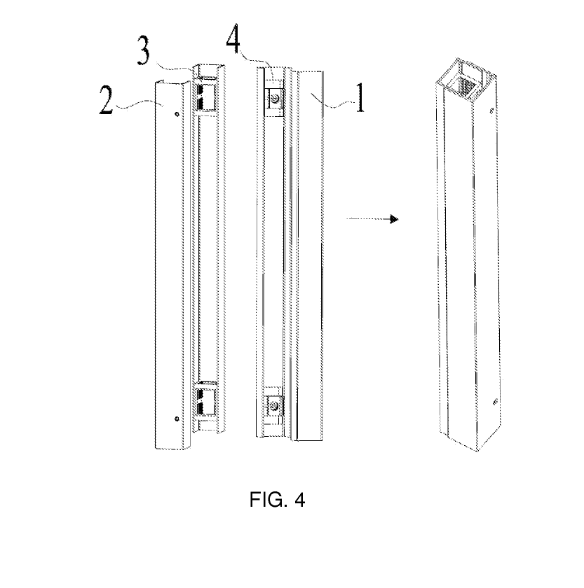

As shown in FIG. 4, the fixing element 3 and the adjusting element 4 are respectively fixed to the stationary frame 1 and the movable frame 2. As the movable frame 2 is moved toward the stationary frame 1, the adjusting block of the adjusting element 4 would extend into the cavity of the fixing element 3, such that the relative position in the right hand side in FIG. 4 can be achieved.

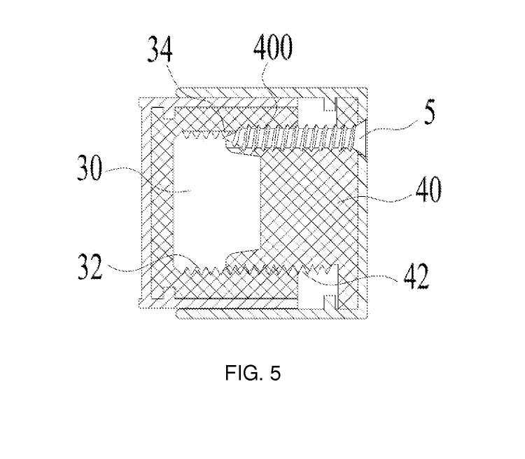

As shown in the detailed structures in FIG. 5, when the adjusting block 40 is received within the cavity 30, an adjusting cavity 400 is defined by the adjusting block 40 and the second inner wall 304. The locking element 5 then can be inserted into the adjusting cavity 400 such that the adjusting block 40 would be pushed toward the first inner wall. Therefore the first engaging element 32 would be engaged with the second engaging element 42, and the relative position between the adjusting element and the fixing element can be fixed.

To adjust the relative position between the movable frame and the stationary frame, the locking element 5 can be released from the adjusting cavity 400. After the movable frame is moved to a suitable position, the locking element 5 can be inserted into the adjusting cavity 400 again, such that the relative position between the movable frame and the stationary frame can be fixed again.

In the example shown in FIGS. 2 and 4, the second inner wall 304 is provided with a third engaging element 34. The third engaging element 34 can be engaged with the locking element 5 after it is inserted into the adjusting cavity, such that the locking element 5 can be fixed in the adjusting cavity 400.

The locking element 5 can extend into the adjusting cavity 400 in various directions, provided that it can act on the inner wall of the adjusting cavity 400 and thereby force the adjusting block toward the first inner wall. As an preferable example, to facilitate the operation of the locking element 5, as shown in FIGS. 1 and 5, the locking element 5 may extend into the adjusting cavity 400 through a locking through hole 20 provided in the movable frame 2.

In the examples shown in the Figures, the locking element 5 is a screw. However, in other alternative examples, the locking element can be elongated structures such as a pin or a wedge block. The locking element 5 has a cross-section larger than that of the adjusting cavity, such that the locking element would act on the latter's inner wall after inserted into it.

The engagement between the first engaging element 32 and the second engaging element 42 provides a fastening force preventing relative movement. This engagement can be accomplished in many ways. In the examples shown in the Figures, the first engaging element 32 and the second engaging element 42 are both tooth shaped or wave shaped structures with an extending direction the same as that of the relative movement, so as to prevent the adjusting element from departing from the cavity.

The fixing element 3 and the adjusting element 4 are respectively fixed detachably to the stationary frame 1 and the movable frame 2. In FIGS. 1 and 2, the fixing element 3 is provided with first slots 36 on both sides, and the stationary frame 1 is provided with protuberances 10 received within the first slots 36. The fixing element 3 is further provided with a first through hole 38 (being sheltered) in the bottom, such that the fixing element 3 can be connected with the stationary frame 1 by a screw inserted through the first through hole 38 and a hole in the stationary frame.

In FIGS. 1 and 3, the adjusting element 4 is provided with a base 44, and the movable frame 2 is provided with second slots 22 for receiving the base 44. The base 44 is provided with a bolt 46 and a bolt hole 460. After both ends of the base 44 are inserted into the second slots 22, the bolt 46 can be inserted into the bolt hole 460 and after which it would withstand the bottom part of the movable frame, such that the base 44 can be kept engaged in the second slots 22 by a force from the opposite direction. At this time, the base 44 is provided with a second through hole 440, the locking element 5 having passed through the locking through hole 20 in the movable frame 2 would then pass through the second through hole 440, in this way it can extend into the adjusting cavity 440.

As shown in FIG. 4, the adjusting assemblies according to the present invention can be respectively arranged on the upper and lower ends of the frame, so as to adjust the relative position between the movable frame and the stationary frame and to ensure that the movable frame is kept in a vertical position.

It should be understood that various example embodiments have been described with reference to the accompanying drawings in which only some example embodiments are shown. The present invention, however, may be embodied in many alternate forms and should not be construed as limited to only the example embodiments set forth herein.

1. A door assembly, comprising a stationary frame and a movable frame, wherein the door assembly further comprises an adjusting assembly comprising
a fixing element detachably connected with the stationary frame and having a cavity, the cavity having oppositely a first inner wall and a second inner wall, the first inner wall being provided with a first engaging element;
an adjusting element detachably connected with the movable frame and having an adjusting block, the adjusting block being capable of being received within the cavity and defining an adjusting cavity together with the second inner wall, the adjusting block being provided with a second engaging element; and
a locking element capable of extending into the adjusting cavity so as to engage the first engaging element with the second engaging element.

2. The door assembly of claim 1, wherein the second inner wall is provided with a third engaging element.

3. The door assembly of claim 1, wherein the locking element extends into the adjusting cavity through a locking through hole provided in the movable frame.

4. The door assembly of claim 1, wherein the locking element is a screw, a pin or a wedge block.

5. The door assembly of claim 1, wherein the first engaging element and the second engaging element are both tooth shaped structures.

6. The door assembly of claim 1, wherein the fixing element is provided with first slots, and the stationary frame is provided with protuberances received within the first slots.

7. The door assembly of claim 6, wherein the fixing element is further provided with a first through hole, and the fixing element is connected with the stationary frame by a screw matching with the first through hole.

8. The door assembly of claim 1, wherein the adjusting element is provided with a base, the movable frame is provided with second slots for receiving the base, and the base is provided with a second through hole for passing through of the locking element.

9. The door assembly of claim 8, wherein the base is provided with a bolt and a bolt hole, and engagement of the bolt and the bolt hole keeps the base engaged in the second slots.

10. The door assembly of claim 1, wherein the door assembly is a shower door assembly or a balcony door assembly.
